(19) United States
(12) Patent Application Publication
(10) Pub. No.: US 2014/0043349 A1
(43) Pub. Date: Feb. 13, 2014

(54) DISPLAY ELEMENT CHANGE DETECTION FOR SELECTIVE LINE UPDATE

(71) Applicants: Manu Parmar, Sunnyvale, CA (US); Jeho Lee, Palo Alto, CA (US); Nao S. Chuei, San Mateo, CA (US); Koorosh Aflatooni, Cupertino, CA (US)

(72) Inventors: Manu Parmar, Sunnyvale, CA (US); Jeho Lee, Palo Alto, CA (US); Nao S. Chuei, San Mateo, CA (US); Koorosh Aflatooni, Cupertino, CA (US)

(73) Assignee: QUALCOMM MEMS Technologies, Inc., San Diego, CA (US)

(21) Appl. No.: 13/570,064

(22) Filed: Aug. 8, 2012

(51) Int. Cl. G09G 5/36

(52) U.S. Cl. 345/547

(57) ABSTRACT

This disclosure provides systems, methods and apparatus, including computer programs encoded on computer storage media, for improving the visual appearance of displayed images at high frame rates by skipping writing lines of display data. In one aspect, clusters of changed image regions are detected, and lines are preferentially written when such clusters are detected.

### TECHNICAL FIELD

This disclosure relates to methods and systems for improving frame rates of display devices with minimal impact to visual performance.

### DESCRIPTION OF THE RELATED TECHNOLOGY

Electromechanical systems include devices having electrical and mechanical elements, actuators, transducers, sensors, optical components (e.g., mirrors) and electronics. Electromechanical systems can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of electromechanical systems device is called an interferometric modulator (IMOD). As used herein, the term interferometric modulator or interferometric light modulator refers to a device that selectively absorbs and/or reflects light using the principles of optical interference. In some implementations, an interferometric modulator may include a pair of conductive plates, one or both of which may be transparent and/or reflective, wholly or in part, and capable of relative motion upon application of an appropriate electrical signal. In an implementation, one plate may include a stationary layer deposited on a substrate and the other plate may include a reflective membrane separated from the stationary layer by an air gap. The position of one plate in relation to another can change the optical interference of light incident on the interferometric modulator. Interferometric modulator devices have a wide range of applications, and are anticipated to be used in improving existing products and creating new products, especially those with display capabilities.

### SUMMARY

The systems, methods and devices of the disclosure each have several innovative aspects, no single one of which is solely responsible for the desirable attributes disclosed herein.

One innovative aspect of the subject matter described in this disclosure can be implemented in a method of writing image data to a display. The method may include determining that a number of adjacent display regions have changed between a portion of a previously written frame of display data and a corresponding portion of a current frame of data to be written, and writing display data of the current frame to the changed adjacent display regions. In some implementations, the method may include writing display data to the changed adjacent display regions when the number is equal to or exceeds a threshold, and retaining original display data on the changed adjacent display regions when the number is less than a threshold. The changed adjacent display regions may be adjacent along a one dimensional line of display data.

In another implementation, a display device may include an array of display elements defining a set of display regions, a driver circuit configured to write display data to the array of display elements, and a processing circuit coupled to the driver circuit configured to determine that a number of adjacent display regions have changed between a portion of a previously written frame of display data and a corresponding portion of a current frame of data to be written. In this implementation, the driver circuit may be configured to write display data of the current frame to the changed adjacent display regions under the control of the processing circuit.

In another implementation, a display device may include means for determining that a number of adjacent display regions have changed between a portion of a previously written frame of display data and a corresponding portion of a current frame of data to be written; and means for writing display data of the current frame to the changed adjacent display regions.

In another implementation, a non-transient computer readable media has instructions stored thereon that cause a processing circuit in a display device to perform the steps of determining that a number of adjacent display regions have changed between a portion of a previously written frame of display data and a corresponding portion of a current frame of data to be written, and writing display data of the current frame to the changed adjacent display regions.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of an isometric view depicting two adjacent pixels in a series of pixels of an interferometric modulator (IMOD) display device.

FIG. 2 shows an example of a system block diagram illustrating an electronic device incorporating a 3×3 interferometric modulator display.

FIG. 3 shows an example of a diagram illustrating movable reflective layer position versus applied voltage for the interferometric modulator of FIG. 1.

FIG. 4 shows an example of a table illustrating various states of an interferometric modulator when various common and segment voltages are applied.

FIG. 5A shows an example of a diagram illustrating a frame of display data in the 3×3 interferometric modulator display of FIG. 2.

FIG. 5B shows an example of a timing diagram for common and segment signals that may be used to write the frame of display data illustrated in FIG. 5A.

FIG. 6A shows an example of a partial cross-section of the interferometric modulator display of FIG. 1.

FIGS. 6B-6E show examples of cross-sections of varying implementations of interferometric modulators.

FIG. 7 shows an example of a flow diagram illustrating a manufacturing process for an interferometric modulator.

FIGS. 8A-8E show examples of cross-sectional schematic illustrations of various stages in a method of making an interferometric modulator.

FIG. 9 shows an example of an array of electromechanical display elements including a plurality of common lines and a plurality of segment lines.

FIG. 10 is a flowchart of a method of writing display data.

FIG. 11 is an example table of image region comparisons.

FIG. 12 is a table of row direction counts based on the table of FIG. 11.

FIG. 13 is a flowchart of a method of writing display data.

FIG. 14 is a circuit that may be used to detect a number of adjacent changed display regions

FIG. 15 is a table containing multiple row logical AND operations performed on the data in the table of FIG. 11.

FIG. 16 is a table of row direction counts based on the table of FIG. 15.

FIG. 17 is another table containing multiple row logical AND operations performed on the data in the table of FIG. 11.

FIGS. 18A and 18B show examples of a display appearance during a scroll operation using a simple count of changed image regions along a line and a detection of clustered changes of image regions along a line.

FIGS. 19A and 19B show examples of system block diagrams illustrating a display device that includes a plurality of interferometric modulators.

Like reference numbers and designations in the various drawings indicate like elements.

### DETAILED DESCRIPTION

The following detailed description is directed to certain implementations for the purposes of describing the innovative aspects. However, the teachings herein can be applied in a multitude of different ways. The described implementations may be implemented in any device that is configured to display an image, whether in motion (e.g., video) or stationary (e.g., still image), and whether textual, graphical or pictorial. More particularly, it is contemplated that the implementations may be implemented in or associated with a variety of electronic devices such as, but not limited to, mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, GPS receivers/navigators, cameras, MP3 players, camcorders, game consoles, wrist watches, clocks, calculators, television monitors, flat panel displays, electronic reading devices (e.g., e-readers), computer monitors, auto displays (e.g., odometer display, etc.), cockpit controls and/or displays, camera view displays (e.g., display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (e.g., MEMS and non-MEMS), aesthetic structures (e.g., display of images on a piece of jewelry) and a variety of electromechanical systems devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes, and electronic test equipment. Thus, the teachings are not intended to be limited to the implementations depicted solely in the Figures, but instead have wide applicability as will be readily apparent to a person having ordinary skill in the art.

When a series of frames are sequentially displayed on a display device, moving objects in the series of frames are better represented visually with a high frame update rate. For some display systems, however, the update rate is limited by the physical nature of the display elements. To increase the update rate, some systems skip the process of updating lines of the image that have not changed between frames. This reduces the time required to write a given frame, since only changed lines are written with new data. To increase the update rate further, some systems determine a total change in image data across a line (e.g. the total number of changed display elements or the total number of changed pixels along a line), and only write the line if the total change is greater than a threshold. Although this will reduce the fidelity of the written image, since some changed lines with changes below the threshold will be skipped, it provides further frame rate increases over skipping only those lines with no change at all. It has been found, however, that the total change across a line is a poor predictor of the visual effect of skipping a given line. Instead, the number of adjacent pixels or display elements along a line that have changed is a better indication of the visual quality cost of skipping a given line. Accordingly, implementations described herein may determine a number of adjacent display regions that have changed, and this number is used in the determination of whether to write the line or not.

Particular implementations of the subject matter described in this disclosure can be implemented to realize one or more of the following potential advantages. Because the number of adjacent changed display regions is determined when deciding what image data to write for a frame, a better balance between frame rate and image fidelity is achieved compared to a scheme in which frame rate is determined by whether a line has changed beyond a threshold without considering whether changed pixels or regions are adjacent to each other. In some cases, more lines can be skipped over prior methods (thereby increasing the frame rate) without degrading the visual appearance of the image. In some cases, skipped lines are selected in a more visually effective way, producing better visual appearance without reducing the frame rate over prior methods.

An example of a suitable MEMS device, to which the described implementations may apply, is a reflective display device. Reflective display devices can incorporate interferometric modulators (IMODs) to selectively absorb and/or reflect light incident thereon using principles of optical interference. IMODs can include an absorber, a reflector that is movable with respect to the absorber, and an optical resonant cavity defined between the absorber and the reflector. The reflector can be moved to two or more different positions, which can change the size of the optical resonant cavity and thereby affect the reflectance of the interferometric modulator. The reflectance spectrums of IMODs can create fairly broad spectral bands which can be shifted across the visible wavelengths to generate different colors. The position of the spectral band can be adjusted by changing the thickness of the optical resonant cavity, i.e., by changing the position of the reflector.

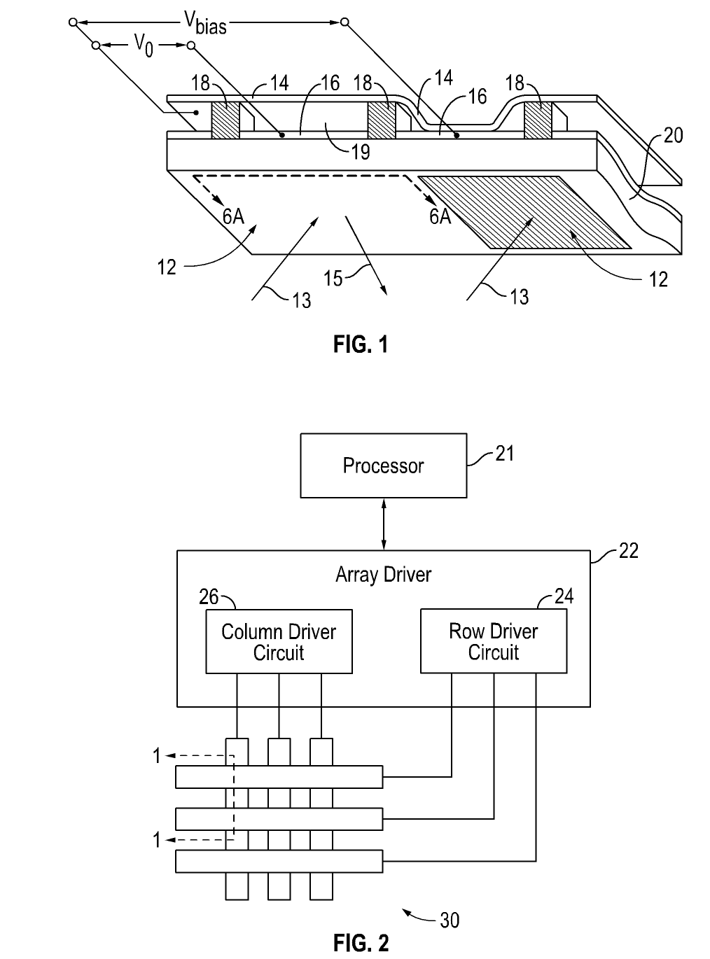

FIG. 1 shows an example of an isometric view depicting two adjacent pixels in a series of pixels of an interferometric modulator (IMOD) display device. The IMOD display device includes one or more interferometric MEMS display elements. In these devices, the pixels of the MEMS display elements can be in either a bright or dark state. In the bright (“relaxed,” “open” or “on”) state, the display element reflects a large portion of incident visible light, e.g., to a user. Conversely, in the dark (“actuated,” “closed” or “off”) state, the display element reflects little incident visible light. In some implementations, the light reflectance properties of the on and off states may be reversed. MEMS pixels can be configured to reflect predominantly at particular wavelengths allowing for a color display in addition to black and white.

The IMOD display device can include a row/column array of IMODs. Each IMOD can include a pair of reflective layers, i.e., a movable reflective layer and a fixed partially reflective layer, positioned at a variable and controllable distance from each other to form an air gap (also referred to as an optical gap or cavity). The movable reflective layer may be moved between at least two positions. In a first position, i.e., a relaxed position, the movable reflective layer can be positioned at a relatively large distance from the fixed partially reflective layer. In a second position, i.e., an actuated position, the movable reflective layer can be positioned more closely to the partially reflective layer. Incident light that reflects from the two layers can interfere constructively or destructively depending on the position of the movable reflective layer, producing either an overall reflective or non-reflective state for each pixel. In some implementations, the IMOD may be in a reflective state when unactuated, reflecting light within the visible spectrum, and may be in a dark state when actuated, reflecting light outside of the visible range (e.g., infrared light). In some other implementations, however, an IMOD may be in a dark state when unactuated, and in a reflective state when actuated. In some implementations, the introduction of an applied voltage can drive the pixels to change states. In some other implementations, an applied charge can drive the pixels to change states.

The depicted portion of the pixel array in FIG. 1 includes two adjacent interferometric modulators 12. In the IMOD 12 on the left (as illustrated), a movable reflective layer 14 is illustrated in a relaxed position at a predetermined distance from an optical stack 16, which includes a partially reflective layer. The voltage Vₒ applied across the IMOD 12 on the left is insufficient to cause actuation of the movable reflective layer 14. In the IMOD 12 on the right, the movable reflective layer 14 is illustrated in an actuated position near or adjacent the optical stack 16. The voltage V_{bias} applied across the IMOD 12 on the right is sufficient to maintain the movable reflective layer 14 in the actuated position.

In FIG. 1, the reflective properties of pixels 12 are generally illustrated with arrows indicating light 13 incident upon the pixels 12, and light 15 reflecting from the pixel 12 on the left. Although not illustrated in detail, it will be understood by a person having ordinary skill in the art that most of the light 13 incident upon the pixels 12 will be transmitted through the transparent substrate 20, toward the optical stack 16. A portion of the light incident upon the optical stack 16 will be transmitted through the partially reflective layer of the optical stack 16, and a portion will be reflected back through the transparent substrate 20. The portion of light 13 that is transmitted through the optical stack 16 will be reflected at the movable reflective layer 14, back toward (and through) the transparent substrate 20. Interference (constructive or destructive) between the light reflected from the partially reflective layer of the optical stack 16 and the light reflected from the movable reflective layer 14 will determine the wavelength(s) of light 15 reflected from the pixel 12.

The optical stack 16 can include a single layer or several layers. The layer(s) can include one or more of an electrode layer, a partially reflective and partially transmissive layer and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals, e.g., chromium (Cr), semiconductors, and dielectrics. The partially reflective layer can be formed of one or more layers of materials, and each of the layers can be formed of a single material or a combination of materials. In some implementations, the optical stack 16 can include a single semi-transparent thickness of metal or semiconductor which serves as both an optical absorber and conductor, while different, more conductive layers or portions (e.g., of the optical stack 16 or of other structures of the IMOD) can serve to bus signals between IMOD pixels. The optical stack 16 also can include one or more insulating or dielectric layers covering one or more conductive layers or a conductive/absorptive layer.

In some implementations, the layer(s) of the optical stack 16 can be patterned into parallel strips, and may form row electrodes in a display device as described further below. As will be understood by one having skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of posts 18 and an intervening sacrificial material deposited between the posts 18. When the sacrificial material is etched away, a defined gap 19, or optical cavity, can be formed between the movable reflective layer 14 and the optical stack 16. In some implementations, the spacing between posts 18 may be approximately 1-1000 um, while the gap 19 may be less than 10,000 Angstroms (Å).

In some implementations, each pixel of the IMOD, whether in the actuated or relaxed state, is essentially a capacitor formed by the fixed and moving reflective layers. When no voltage is applied, the movable reflective layer 14 remains in a mechanically relaxed state, as illustrated by the pixel 12 on the left in FIG. 1, with the gap 19 between the movable reflective layer 14 and optical stack 16. However, when a potential difference, e.g., voltage, is applied to at least one of a selected row and column, the capacitor formed at the intersection of the row and column electrodes at the corresponding pixel becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated pixel 12 on the right in FIG. 1. The behavior is the same regardless of the polarity of the applied potential difference. Though a series of pixels in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

FIG. 2 shows an example of a system block diagram illustrating an electronic device incorporating a 3×3 interferometric modulator display. The electronic device includes a processor 21 that may be configured to execute one or more software modules. In addition to executing an operating system, the processor 21 may be configured to execute one or more software applications, including a web browser, a telephone application, an email program, or any other software application.

The processor 21 can be configured to communicate with an array driver 22. The array driver 22 can include a row driver circuit 24 and a column driver circuit 26 that provide signals to, e.g., a display array or panel 30. The cross section of the IMOD display device illustrated in FIG. 1 is shown by the lines 1-1 in FIG. 2. Although FIG. 2 illustrates a 3×3 array of IMODs for the sake of clarity, the display array 30 may contain a very large number of IMODs, and may have a different number of IMODs in rows than in columns, and vice versa.

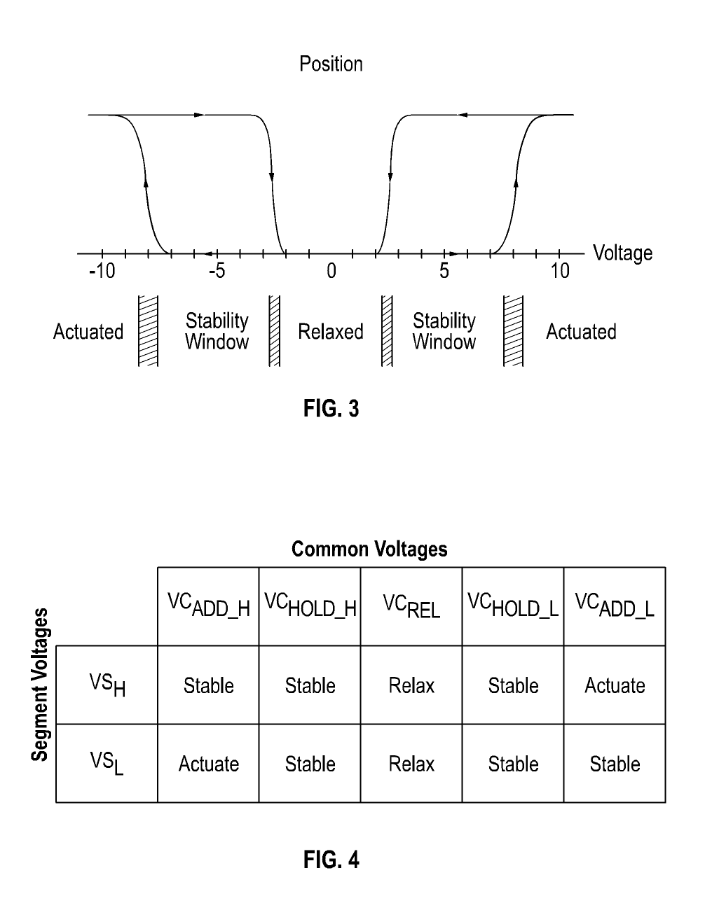

FIG. 3 shows an example of a diagram illustrating movable reflective layer position versus applied voltage for the interferometric modulator of FIG. 1. For MEMS interferometric modulators, the row/column (i.e., common/segment) write procedure may take advantage of a hysteresis property of these devices as illustrated in FIG. 3. An interferometric modulator may require, for example, about a 10-volt potential difference to cause the movable reflective layer, or mirror, to change from the relaxed state to the actuated state. When the voltage is reduced from that value, the movable reflective layer maintains its state as the voltage drops back below, e.g., 10-volts, however, the movable reflective layer does not relax completely until the voltage drops below 2-volts. Thus, a range of voltage, approximately 3 to 7-volts, as shown in FIG. 3, exists where there is a window of applied voltage within which the device is stable in either the relaxed or actuated state. This is referred to herein as the “hysteresis window” or “stability window.” For a display array 30 having the hysteresis characteristics of FIG. 3, the row/column write procedure can be designed to address one or more rows at a time, such that during the addressing of a given row, pixels in the addressed row that are to be actuated are exposed to a voltage difference of about 10-volts, and pixels that are to be relaxed are exposed to a voltage difference of near zero volts. After addressing, the pixels are exposed to a steady state or bias voltage difference of approximately 5-volts such that they remain in the previous strobing state. In this example, after being addressed, each pixel sees a potential difference within the “stability window” of about 3-7-volts. This hysteresis property feature enables the pixel design, e.g., illustrated in FIG. 1, to remain stable in either an actuated or relaxed pre-existing state under the same applied voltage conditions. Since each IMOD pixel, whether in the actuated or relaxed state, is essentially a capacitor formed by the fixed and moving reflective layers, this stable state can be held at a steady voltage within the hysteresis window without substantially consuming or losing power. Moreover, essentially little or no current flows into the IMOD pixel if the applied voltage potential remains substantially fixed.

In some implementations, a frame of an image may be created by applying data signals in the form of “segment” voltages along the set of column electrodes, in accordance with the desired change (if any) to the state of the pixels in a given row. Each row of the array can be addressed in turn, such that the frame is written one row at a time. To write the desired data to the pixels in a first row, segment voltages corresponding to the desired state of the pixels in the first row can be applied on the column electrodes, and a first row pulse in the form of a specific “common” voltage or signal can be applied to the first row electrode. The set of segment voltages can then be changed to correspond to the desired change (if any) to the state of the pixels in the second row, and a second common voltage can be applied to the second row electrode. In some implementations, the pixels in the first row are unaffected by the change in the segment voltages applied along the column electrodes, and remain in the state they were set to during the first common voltage row pulse. This process may be repeated for the entire series of rows, or alternatively, columns, in a sequential fashion to produce the image frame. The frames can be refreshed and/or updated with new image data by continually repeating this process at some desired number of frames per second.

The combination of segment and common signals applied across each pixel (that is, the potential difference across each pixel) determines the resulting state of each pixel. FIG. 4 shows an example of a table illustrating various states of an interferometric modulator when various common and segment voltages are applied. As will be readily understood by one having ordinary skill in the art, the “segment” voltages can be applied to either the column electrodes or the row electrodes, and the “common” voltages can be applied to the other of the column electrodes or the row electrodes.

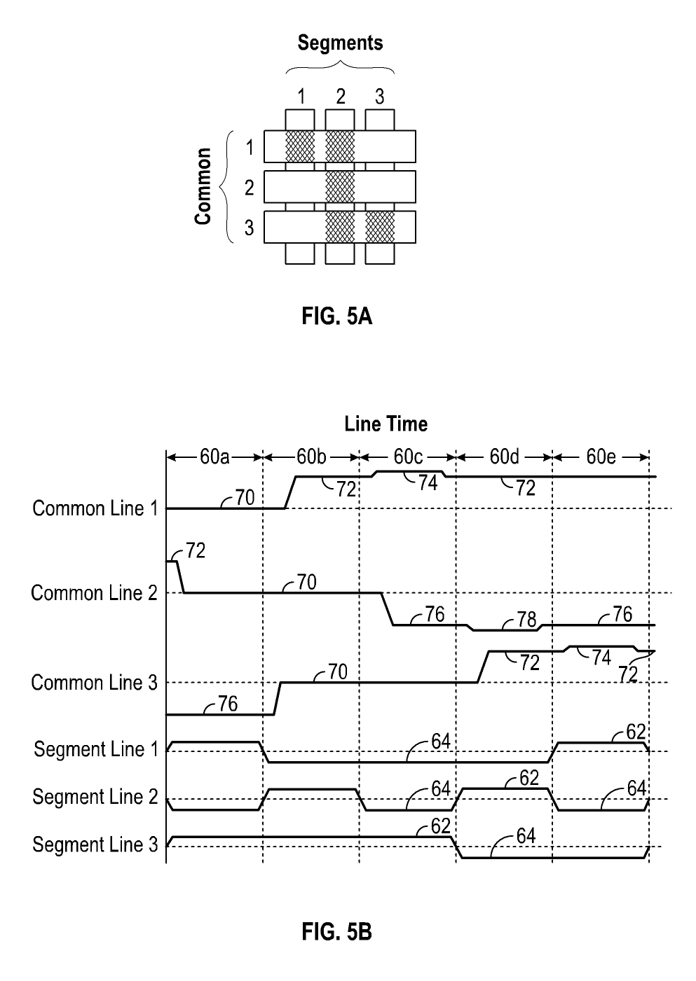

As illustrated in FIG. 4 (as well as in the timing diagram shown in FIG. 5B), when a release voltage VC_{REL} is applied along a common line, all interferometric modulator elements along the common line will be placed in a relaxed state, alternatively referred to as a released or unactuated state, regardless of the voltage applied along the segment lines, i.e., high segment voltage VS_{H} and low segment voltage VS_{L}. In particular, when the release voltage VC_{REL} is applied along a common line, the potential voltage across the modulator (alternatively referred to as a pixel voltage) is within the relaxation window (see FIG. 3, also referred to as a release window) both when the high segment voltage VS_{H} and the low segment voltage VS_{L} are applied along the corresponding segment line for that pixel.

When a hold voltage is applied on a common line, such as a high hold voltage VC_{HOLD}_{_{—}}_{H} or a low hold voltage VC_{HOLD}_{_{—}}_{L}, the state of the interferometric modulator will remain constant. For example, a relaxed IMOD will remain in a relaxed position, and an actuated IMOD will remain in an actuated position. The hold voltages can be selected such that the pixel voltage will remain within a stability window both when the high segment voltage VS_{H} and the low segment voltage VS_{L} are applied along the corresponding segment line. Thus, the segment voltage swing, i.e., the difference between the high VS_{H} and low segment voltage VS_{L}, is less than the width of either the positive or the negative stability window.

When an addressing, or actuation, voltage is applied on a common line, such as a high addressing voltage VC_{ADD}_{_{—}}_{H} or a low addressing voltage VC_{ADD}_{_{—}}_{L}, data can be selectively written to the modulators along that line by application of segment voltages along the respective segment lines. The segment voltages may be selected such that actuation is dependent upon the segment voltage applied. When an addressing voltage is applied along a common line, application of one segment voltage will result in a pixel voltage within a stability window, causing the pixel to remain unactuated. In contrast, application of the other segment voltage will result in a pixel voltage beyond the stability window, resulting in actuation of the pixel. The particular segment voltage which causes actuation can vary depending upon which addressing voltage is used. In some implementations, when the high addressing voltage VC_{ADD}_{_{—}}_{H} is applied along the common line, application of the high segment voltage VS_{H} can cause a modulator to remain in its current position, while application of the low segment voltage VS_{L} can cause actuation of the modulator. As a corollary, the effect of the segment voltages can be the opposite when a low addressing voltage VC_{ADD}_{_{—}}_{L} is applied, with high segment voltage VS_{H} causing actuation of the modulator, and low segment voltage VS_{L} having no effect (i.e., remaining stable) on the state of the modulator.

In some implementations, hold voltages, address voltages, and segment voltages may be used which always produce the same polarity potential difference across the modulators. In some other implementations, signals can be used which alternate the polarity of the potential difference of the modulators. Alternation of the polarity across the modulators (that is, alternation of the polarity of write procedures) may reduce or inhibit charge accumulation which could occur after repeated write operations of a single polarity.

FIG. 5A shows an example of a diagram illustrating a frame of display data in the 3×3 interferometric modulator display of FIG. 2. FIG. 5B shows an example of a timing diagram for common and segment signals that may be used to write the frame of display data illustrated in FIG. 5A. The signals can be applied to the, e.g., 3×3 array of FIG. 2, which will ultimately result in the line time 60e display arrangement illustrated in FIG. 5A. The actuated modulators in FIG. 5A are in a dark-state, i.e., where a substantial portion of the reflected light is outside of the visible spectrum so as to result in a dark appearance to, e.g., a viewer. Prior to writing the frame illustrated in FIG. 5A, the pixels can be in any state, but the write procedure illustrated in the timing diagram of FIG. 5B presumes that each modulator has been released and resides in an unactuated state before the first line time 60a.

During the first line time 60a: a release voltage 70 is applied on common line 1; the voltage applied on common line 2 begins at a high hold voltage 72 and moves to a release voltage 70; and a low hold voltage 76 is applied along common line 3. Thus, the modulators (common 1, segment 1), (1,2) and (1,3) along common line 1 remain in a relaxed, or unactuated, state for the duration of the first line time 60a, the modulators (2,1), (2,2) and (2,3) along common line 2 will move to a relaxed state, and the modulators (3,1), (3,2) and (3,3) along common line 3 will remain in their previous state. With reference to FIG. 4, the segment voltages applied along segment lines 1, 2 and 3 will have no effect on the state of the interferometric modulators, as none of common lines 1, 2 or 3 are being exposed to voltage levels causing actuation during line time 60a (i.e., VC_{REL}-relax and VC_{HOLD}_{_{—}}_{L}-stable).

During the second line time 60b, the voltage on common line 1 moves to a high hold voltage 72, and all modulators along common line 1 remain in a relaxed state regardless of the segment voltage applied because no addressing, or actuation, voltage was applied on the common line 1. The modulators along common line 2 remain in a relaxed state due to the application of the release voltage 70, and the modulators (3,1), (3,2) and (3,3) along common line 3 will relax when the voltage along common line 3 moves to a release voltage 70.

During the third line time 60c, common line 1 is addressed by applying a high address voltage 74 on common line 1. Because a low segment voltage 64 is applied along segment lines 1 and 2 during the application of this address voltage, the pixel voltage across modulators (1,1) and (1,2) is greater than the high end of the positive stability window (i.e., the voltage differential exceeded a predefined threshold) of the modulators, and the modulators (1,1) and (1,2) are actuated. Conversely, because a high segment voltage 62 is applied along segment line 3, the pixel voltage across modulator (1,3) is less than that of modulators (1,1) and (1,2), and remains within the positive stability window of the modulator; modulator (1,3) thus remains relaxed. Also during line time 60c, the voltage along common line 2 decreases to a low hold voltage 76, and the voltage along common line 3 remains at a release voltage 70, leaving the modulators along common lines 2 and 3 in a relaxed position.

During the fourth line time 60d, the voltage on common line 1 returns to a high hold voltage 72, leaving the modulators along common line 1 in their respective addressed states. The voltage on common line 2 is decreased to a low address voltage 78. Because a high segment voltage 62 is applied along segment line 2, the pixel voltage across modulator (2,2) is below the lower end of the negative stability window of the modulator, causing the modulator (2,2) to actuate. Conversely, because a low segment voltage 64 is applied along segment lines 1 and 3, the modulators (2,1) and (2,3) remain in a relaxed position. The voltage on common line 3 increases to a high hold voltage 72, leaving the modulators along common line 3 in a relaxed state.

Finally, during the fifth line time 60e, the voltage on common line 1 remains at high hold voltage 72, and the voltage on common line 2 remains at a low hold voltage 76, leaving the modulators along common lines 1 and 2 in their respective addressed states. The voltage on common line 3 increases to a high address voltage 74 to address the modulators along common line 3. As a low segment voltage 64 is applied on segment lines 2 and 3, the modulators (3,2) and (3,3) actuate, while the high segment voltage 62 applied along segment line 1 causes modulator (3,1) to remain in a relaxed position. Thus, at the end of the fifth line time 60e, the 3×3 pixel array is in the state shown in FIG. 5A, and will remain in that state as long as the hold voltages are applied along the common lines, regardless of variations in the segment voltage which may occur when modulators along other common lines (not shown) are being addressed.

In the timing diagram of FIG. 5B, a given write procedure (i.e., line times 60a-60e) can include the use of either high hold and address voltages, or low hold and address voltages. Once the write procedure has been completed for a given common line (and the common voltage is set to the hold voltage having the same polarity as the actuation voltage), the pixel voltage remains within a given stability window, and does not pass through the relaxation window until a release voltage is applied on that common line. Furthermore, as each modulator is released as part of the write procedure prior to addressing the modulator, the actuation time of a modulator, rather than the release time, may determine the necessary line time. Specifically, in implementations in which the release time of a modulator is greater than the actuation time, the release voltage may be applied for longer than a single line time, as depicted in FIG. 5B. In some other implementations, voltages applied along common lines or segment lines may vary to account for variations in the actuation and release voltages of different modulators, such as modulators of different colors.

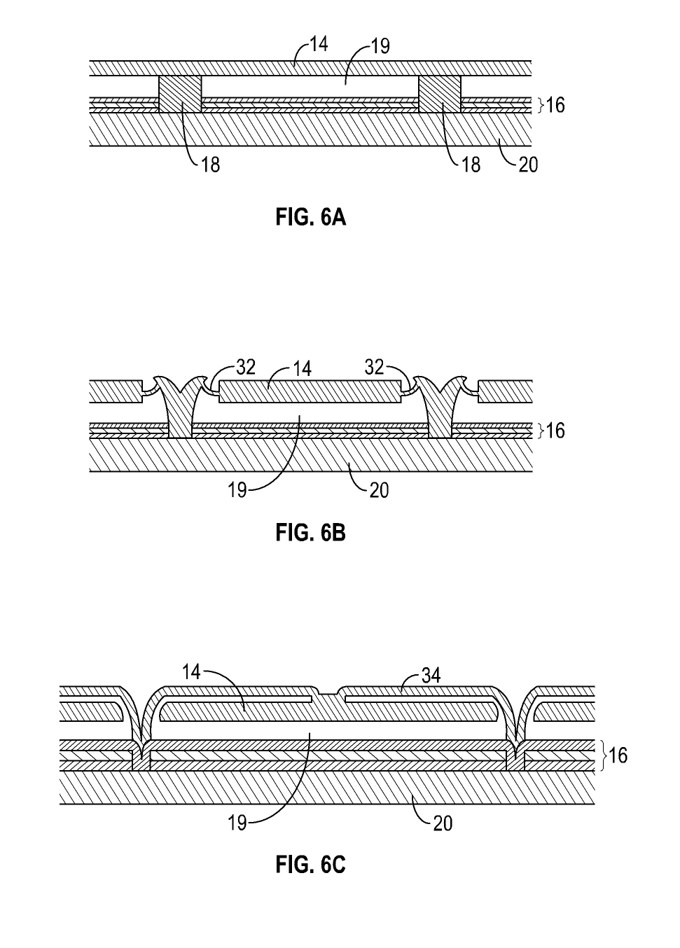

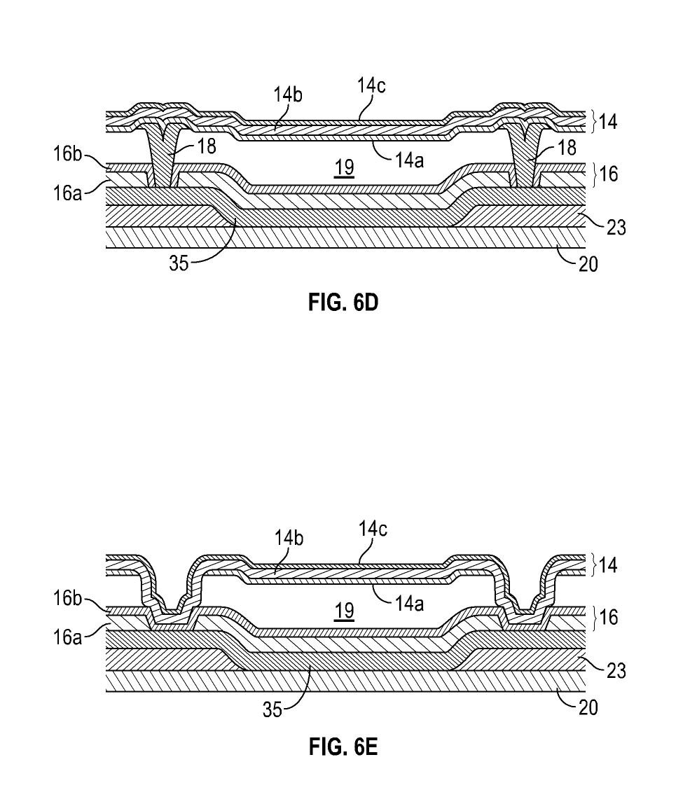

The details of the structure of interferometric modulators that operate in accordance with the principles set forth above may vary widely. For example, FIGS. 6A-6E show examples of cross-sections of varying implementations of interferometric modulators, including the movable reflective layer 14 and its supporting structures. FIG. 6A shows an example of a partial cross-section of the interferometric modulator display of FIG. 1, where a strip of metal material, i.e., the movable reflective layer 14 is deposited on supports 18 extending orthogonally from the substrate 20. In FIG. 6B, the movable reflective layer 14 of each IMOD is generally square or rectangular in shape and attached to supports at or near the corners, on tethers 32. In FIG. 6C, the movable reflective layer 14 is generally square or rectangular in shape and suspended from a deformable layer 34, which may include a flexible metal. The deformable layer 34 can connect, directly or indirectly, to the substrate 20 around the perimeter of the movable reflective layer 14. These connections are herein referred to as support posts. The implementation shown in FIG. 6C has additional benefits deriving from the decoupling of the optical functions of the movable reflective layer 14 from its mechanical functions, which are carried out by the deformable layer 34. This decoupling allows the structural design and materials used for the reflective layer 14 and those used for the deformable layer 34 to be optimized independently of one another.

FIG. 6D shows another example of an IMOD, where the movable reflective layer 14 includes a reflective sub-layer 14a. The movable reflective layer 14 rests on a support structure, such as support posts 18. The support posts 18 provide separation of the movable reflective layer 14 from the lower stationary electrode (i.e., part of the optical stack 16 in the illustrated IMOD) so that a gap 19 is formed between the movable reflective layer 14 and the optical stack 16; for example when the movable reflective layer 14 is in a relaxed position. The movable reflective layer 14 also can include a conductive layer 14c, which may be configured to serve as an electrode, and a support layer 14b. In this example, the conductive layer 14c is disposed on one side of the support layer 14b, distal from the substrate 20, and the reflective sub-layer 14a is disposed on the other side of the support layer 14b, proximal to the substrate 20. In some implementations, the reflective sub-layer 14a can be conductive and can be disposed between the support layer 14b and the optical stack 16. The support layer 14b can include one or more layers of a dielectric material, for example, silicon oxynitride (SiON) or silicon dioxide (SiO₂). In some implementations, the support layer 14b can be a stack of layers, such as, for example, a SiO₂/SiON/SiO₂ tri-layer stack. Either or both of the reflective sub-layer 14a and the conductive layer 14c can include, e.g., an aluminum (Al) alloy with about 0.5% copper (Cu), or another reflective metallic material. Employing conductive layers 14a, 14c above and below the dielectric support layer 14b can balance stresses and provide enhanced conduction. In some implementations, the reflective sub-layer 14a and the conductive layer 14c can be formed of different materials for a variety of design purposes, such as achieving specific stress profiles within the movable reflective layer 14.

As illustrated in FIG. 6D, some implementations also can include a black mask structure 23. The black mask structure 23 can be formed in optically inactive regions (e.g., between pixels or under posts 18) to absorb ambient or stray light. The black mask structure 23 also can improve the optical properties of a display device by inhibiting light from being reflected from or transmitted through inactive portions of the display, thereby increasing the contrast ratio. Additionally, the black mask structure 23 can be conductive and be configured to function as an electrical bussing layer. In some implementations, the row electrodes can be connected to the black mask structure 23 to reduce the resistance of the connected row electrode. The black mask structure 23 can be formed using a variety of methods, including deposition and patterning techniques. The black mask structure 23 can include one or more layers. For example, in some implementations, the black mask structure 23 includes a molybdenum-chromium (MoCr) layer that serves as an optical absorber, a layer, and an aluminum alloy that serves as a reflector and a bussing layer, with a thickness in the range of about 30-80 Å, 500-1000 Å, and 500-6000 Å, respectively. The one or more layers can be patterned using a variety of techniques, including photolithography and dry etching, including, for example, carbon tetrafluoride (CF₄) and/or oxygen (O₂) for the MoCr and SiO₂ layers and chlorine (Cl₂) and/or boron trichloride (BCl₃) for the aluminum alloy layer. In some implementations, the black mask 23 can be an etalon or interferometric stack structure. In such interferometric stack black mask structures 23, the conductive absorbers can be used to transmit or bus signals between lower, stationary electrodes in the optical stack 16 of each row or column. In some implementations, a spacer layer 35 can serve to generally electrically isolate the absorber layer 16a from the conductive layers in the black mask 23.

FIG. 6E shows another example of an IMOD, where the movable reflective layer 14 is self supporting. In contrast with FIG. 6D, the implementation of FIG. 6E does not include support posts 18. Instead, the movable reflective layer 14 contacts the underlying optical stack 16 at multiple locations, and the curvature of the movable reflective layer 14 provides sufficient support that the movable reflective layer 14 returns to the unactuated position of FIG. 6E when the voltage across the interferometric modulator is insufficient to cause actuation. The optical stack 16, which may contain a plurality of several different layers, is shown here for clarity including an optical absorber 16a, and a dielectric 16b. In some implementations, the optical absorber 16a may serve both as a fixed electrode and as a partially reflective layer.

In implementations such as those shown in FIGS. 6A-6E, the IMODs function as direct-view devices, in which images are viewed from the front side of the transparent substrate 20, i.e., the side opposite to that upon which the modulator is arranged. In these implementations, the back portions of the device (that is, any portion of the display device behind the movable reflective layer 14, including, for example, the deformable layer 34 illustrated in FIG. 6C) can be configured and operated upon without impacting or negatively affecting the image quality of the display device, because the reflective layer 14 optically shields those portions of the device. For example, in some implementations a bus structure (not illustrated) can be included behind the movable reflective layer 14 which provides the ability to separate the optical properties of the modulator from the electromechanical properties of the modulator, such as voltage addressing and the movements that result from such addressing. Additionally, the implementations of FIGS. 6A-6E can simplify processing, such as, e.g., patterning.

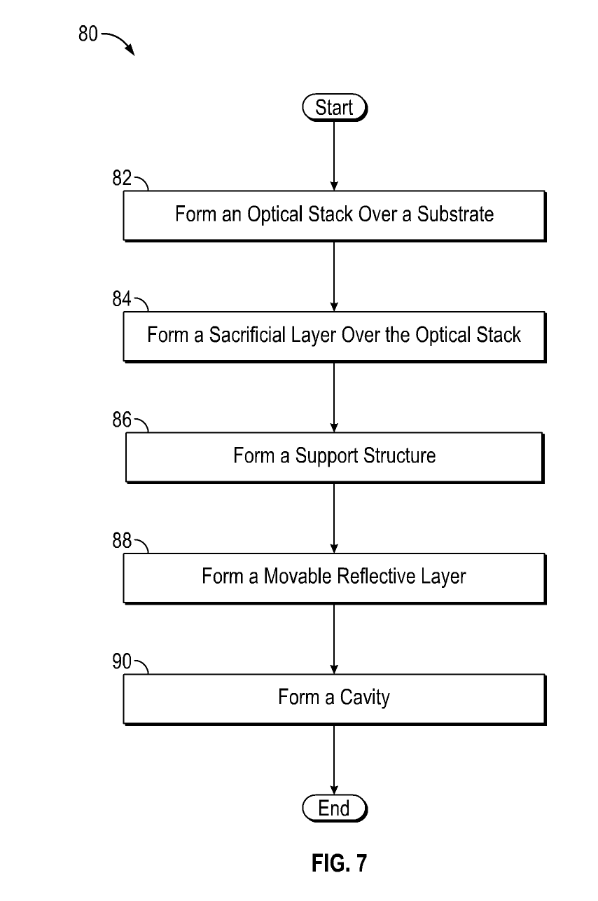

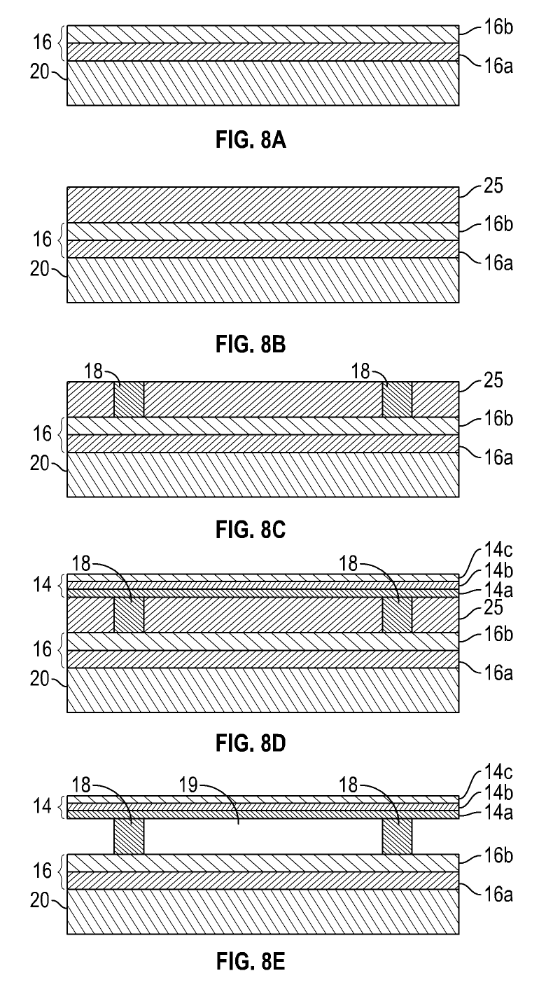

FIG. 7 shows an example of a flow diagram illustrating a manufacturing process 80 for an interferometric modulator, and FIGS. 8A-8E show examples of cross-sectional schematic illustrations of corresponding stages of such a manufacturing process 80. In some implementations, the manufacturing process 80 can be implemented to manufacture, e.g., interferometric modulators of the general type illustrated in FIGS. 1 and 6, in addition to other blocks not shown in FIG. 7. With reference to FIGS. 1, 6 and 7, the process 80 begins at block 82 with the formation of the optical stack 16 over the substrate 20. FIG. 8A illustrates such an optical stack 16 formed over the substrate 20. The substrate 20 may be a transparent substrate such as glass or plastic, it may be flexible or relatively stiff and unbending, and may have been subjected to prior preparation processes, e.g., cleaning, to facilitate efficient formation of the optical stack 16. As discussed above, the optical stack 16 can be electrically conductive, partially transparent and partially reflective and may be fabricated, for example, by depositing one or more layers having the desired properties onto the transparent substrate 20. In FIG. 8A, the optical stack 16 includes a multilayer structure having sub-layers 16a and 16b, although more or fewer sub-layers may be included in some other implementations. In some implementations, one of the sub-layers 16a, 16b can be configured with both optically absorptive and conductive properties, such as the combined conductor/absorber sub-layer 16a. Additionally, one or more of the sub-layers 16a, 16b can be patterned into parallel strips, and may form row electrodes in a display device. Such patterning can be performed by a masking and etching process or another suitable process known in the art. In some implementations, one of the sub-layers 16a, 16b can be an insulating or dielectric layer, such as sub-layer 16b that is deposited over one or more metal layers (e.g., one or more reflective and/or conductive layers). In addition, the optical stack 16 can be patterned into individual and parallel strips that form the rows of the display.

The process 80 continues at block 84 with the formation of a sacrificial layer 25 over the optical stack 16. The sacrificial layer 25 is later removed (e.g., at block 90) to form the cavity 19 and thus the sacrificial layer 25 is not shown in the resulting interferometric modulators 12 illustrated in FIG. 1. FIG. 8B illustrates a partially fabricated device including a sacrificial layer 25 formed over the optical stack 16. The formation of the sacrificial layer 25 over the optical stack 16 may include deposition of a xenon difluoride (XeF₂)-etchable material such as molybdenum (Mo) or amorphous silicon (a-Si), in a thickness selected to provide, after subsequent removal, a gap or cavity 19 (see also FIGS. 1 and 8E) having a desired design size. Deposition of the sacrificial material may be carried out using deposition techniques such as physical vapor deposition (PVD, e.g., sputtering), plasma-enhanced chemical vapor deposition (PECVD), thermal chemical vapor deposition (thermal CVD), or spin-coating.

The process 80 continues at block 86 with the formation of a support structure e.g., a post 18 as illustrated in FIGS. 1, 6 and 8C. The formation of the post 18 may include patterning the sacrificial layer 25 to form a support structure aperture, then depositing a material (e.g., a polymer or an inorganic material, e.g., silicon oxide) into the aperture to form the post 18, using a deposition method such as PVD, PECVD, thermal CVD, or spin-coating. In some implementations, the support structure aperture formed in the sacrificial layer can extend through both the sacrificial layer 25 and the optical stack 16 to the underlying substrate 20, so that the lower end of the post 18 contacts the substrate 20 as illustrated in FIG. 6A. Alternatively, as depicted in FIG. 8C, the aperture formed in the sacrificial layer 25 can extend through the sacrificial layer 25, but not through the optical stack 16. For example, FIG. 8E illustrates the lower ends of the support posts 18 in contact with an upper surface of the optical stack 16. The post 18, or other support structures, may be formed by depositing a layer of support structure material over the sacrificial layer 25 and patterning portions of the support structure material located away from apertures in the sacrificial layer 25. The support structures may be located within the apertures, as illustrated in FIG. 8C, but also can, at least partially, extend over a portion of the sacrificial layer 25. As noted above, the patterning of the sacrificial layer 25 and/or the support posts 18 can be performed by a patterning and etching process, but also may be performed by alternative etching methods.

The process 80 continues at block 88 with the formation of a movable reflective layer or membrane such as the movable reflective layer 14 illustrated in FIGS. 1, 6 and 8D. The movable reflective layer 14 may be formed by employing one or more deposition steps, e.g., reflective layer (e.g., aluminum, aluminum alloy) deposition, along with one or more patterning, masking, and/or etching steps. The movable reflective layer 14 can be electrically conductive, and referred to as an electrically conductive layer. In some implementations, the movable reflective layer 14 may include a plurality of sub-layers 14a, 14b, 14c as shown in FIG. 8D. In some implementations, one or more of the sub-layers, such as sub-layers 14a, 14c, may include highly reflective sub-layers selected for their optical properties, and another sub-layer 14b may include a mechanical sub-layer selected for its mechanical properties. Since the sacrificial layer 25 is still present in the partially fabricated interferometric modulator formed at block 88, the movable reflective layer 14 is typically not movable at this stage. A partially fabricated IMOD that contains a sacrificial layer 25 may also be referred to herein as an “unreleased” IMOD. As described above in connection with FIG. 1, the movable reflective layer 14 can be patterned into individual and parallel strips that form the columns of the display.

The process 80 continues at block 90 with the formation of a cavity, e.g., cavity 19 as illustrated in FIGS. 1, 6 and 8E. The cavity 19 may be formed by exposing the sacrificial material 25 (deposited at block 84) to an etchant. For example, an etchable sacrificial material such as Mo or amorphous Si may be removed by dry chemical etching, e.g., by exposing the sacrificial layer 25 to a gaseous or vaporous etchant, such as vapors derived from solid XeF₂ for a period of time that is effective to remove the desired amount of material, typically selectively removed relative to the structures surrounding the cavity 19. Other etching methods, e.g. wet etching and/or plasma etching, also may be used. Since the sacrificial layer 25 is removed during block 90, the movable reflective layer 14 is typically movable after this stage. After removal of the sacrificial material 25, the resulting fully or partially fabricated IMOD may be referred to herein as a “released” IMOD.

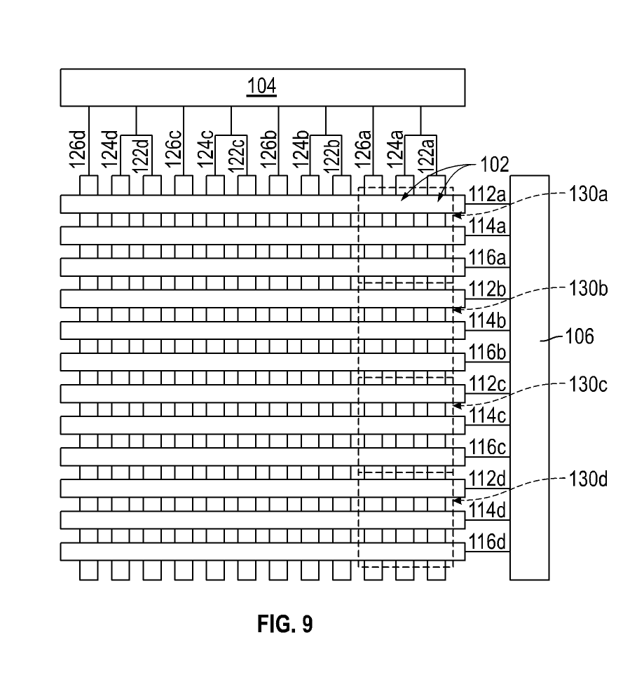

FIG. 9 shows an example of an array 100 of electromechanical display elements 102 including a plurality of common lines and a plurality of segment lines. In certain implementations, the electromechanical display elements 102 may include interferometric modulators such as described above where the segment lines and common lines intersect. A plurality of segment electrodes or segment lines 122 (i.e., 122a, 122b, 122c, 122d, etc.), 124, and 126 and a plurality of common electrodes or common lines 112, 114, and 116 can be used to address the display elements 102, as each display element will be in electrical communication with a segment electrode and a common electrode. Segment driver circuitry 104 is configured to apply desired voltage waveforms across each of the segment electrodes, and common driver circuitry 106 is configured to apply desired voltage waveforms across each of the column electrodes. In certain implementations, some of the electrodes may be in electrical communication with one another, such as segment electrodes 122a and 124a, such that the same voltage waveform can be simultaneously applied across each of the segment electrodes.

Still with reference to FIG. 9, in an implementation in which the display 100 includes a color display or a monochrome grayscale display, the individual electromechanical elements 102 may form elements of logical image pixels, where the pixels include some number of display elements, In an implementation in which the array includes a color display including a plurality of interferometric modulators, the various colors may be aligned along common lines, such that substantially all of the display elements along a given common line include display elements configured to display the same color. Certain implementations of color displays include alternating lines of red, green, and blue display elements. For example, lines 112 may correspond to lines of red interferometric modulators, lines 114 may correspond to lines of green interferometric modulators, and lines 116 may correspond to lines of blue interferometric modulators. In a particular implementation, each 3×3 array of interferometric modulators 102 forms a pixel such as pixels 130a-130d. In the illustrated implementation in which two of the segment electrodes are shorted to one another, such a 3×3 pixel will be capable of rendering 64 different colors. In other implementations, larger groups of interferometric modulators may be used to form pixels having a greater color range at the cost of overall pixel count or resolution.

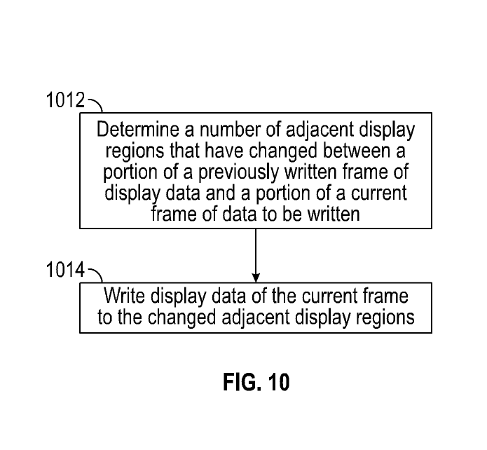

Because the common lines 112, 114, and 116 are typically written sequentially and individually as a frame is written, often from the top to the bottom of the display, the time required to write a frame of image data when all the lines are being individually addressed is the individual line time (see 60a-60e of FIG. 5B for example) multiplied by the number of common lines. As described briefly above, it is sometimes possible to increase the frame rate when it is possible to skip writing new data to some common lines. For example, if some common lines in a new frame are the same as the old frame, these lines can be skipped, and the old data may persist on the lines without any effect on the image displayed for the new frame. Generally, such a scheme involves comparing the image data for a common line that is about to be written in a new frame to the data in the corresponding line of the frame currently displayed. If they are the same, the write process and associated line time for that line is skipped, and the procedure is repeated for the next common line of the new frame. In some cases, lines can be skipped even if there is some change on the line. This is because some changes are essentially invisible to the viewer, so maintaining the previous frame data on the line for the new frame does not appreciably affect the visual quality of the image even though there is old and different data on the line. Specifically, it has been found that changes to the image data between frames are more visually perceptible when the changes are formed into adjacent groups. It is often the case that 10 or 20 display element state changes between frames that are scattered along an entire line are visually imperceptible if the old data is left in place when a new frame is written, but if the 10 or 20 display element state changes between frames are adjacent to one another, the user can clearly perceive a defect in the new frame. A frame writing process that takes advantage of this fact is illustrated in FIG. 10.

FIG. 10 is a flowchart of a method of writing display data. The method begins at block 1012. At block 1012, the method will determine a number of adjacent display regions that have changed between a portion of a previously written frame of display data and a portion of a current frame of data to be written. After determining a number of adjacent changed display regions, the method moves to block 1014, where the method writes display data of the current frame to the changed adjacent display regions. This method may ensure that new data is written to those sections of the display containing a number of adjacent changed display regions that is equal to or above some threshold number. The method may also allow skipping the write process for those sections of the display that contain fewer adjacent changed display regions than the threshold.

The “display regions” which are compared can be of any size. In one implementation, each display region is a single display element such as a single interferometric modulator. In this implementation with interferometric modulators, a display region is changed if the modulator is released in one frame and actuated in the next, or actuated in one frame and released in the next. Furthermore in this implementation, the portion of the previous frame and the portion of the frame being written that are compared can be corresponding common lines of the display. A number “n” of adjacent changed display regions is present when a continuous series of n or more adjacent interferometric modulators are set to different states between the two frames. A method of writing display data in this implementation may search for a continuous series of n or more changed display elements along a common line, and write the line only if such a continuous series is found.

In another implementation, each display region is a pixel that may contain multiple individual display elements, like the three by three element pixels 130a-130d of FIG. 9. In this implementation, the display region may be considered changed if any one of the display elements that constitute the pixel is different between frames. Furthermore, in this implementation, the portion of the previous frame and the portion of the frame being written that are compared can be corresponding lines of pixels of the display. In the pixel implementation of FIG. 9, this would correspond to three common lines of the display. A number “n” of adjacent changed display regions is present when a continuous series of n or more adjacent pixels have one or more modulators of different states between the two frames. A method of writing display data in this implementation may search for a continuous series of n or more changed pixels along a set of common lines, and write the pixels only if such a continuous series is found. In a display with multiple common lines spanning a pixel, this would involve writing all of the lines that form the line of pixels (e.g. three common lines for a pixel as in FIG. 9). Larger groups of display elements such as groups of pixels could also be “display regions” that are compared.

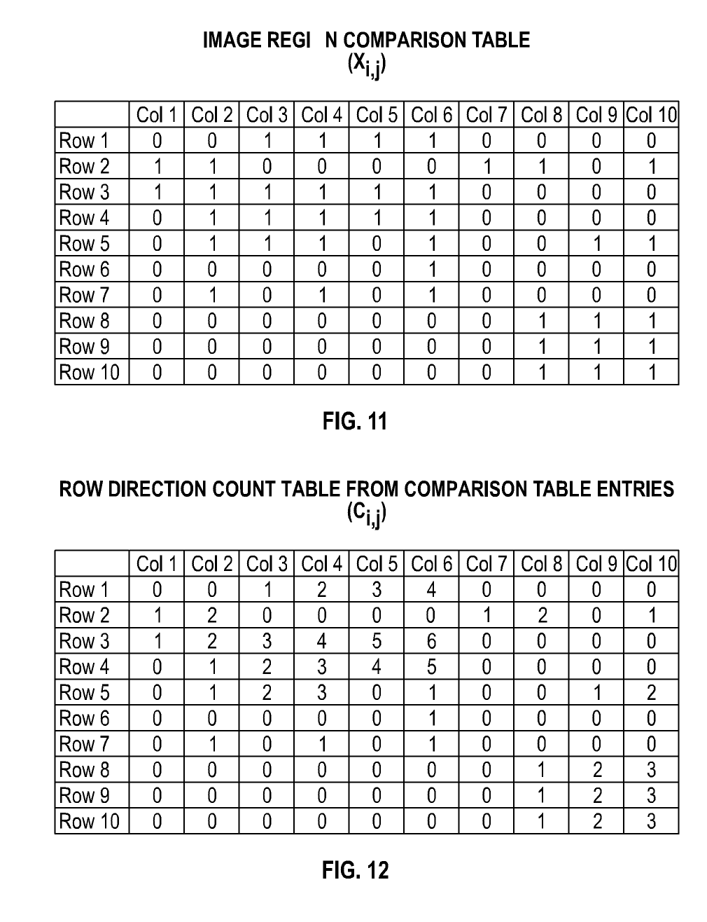

FIGS. 11-14 illustrate various ways that a number of adjacent display regions that are changed can be found. Initially, FIG. 11 is an example table of image region comparisons. In this example, assuming the table represents the entire display, the display is considered to be a 10×10 array of image regions. As described above, these image regions can be individual display elements, pixels, or any other size image region. The state of the image region is referred to herein as I_{i,j,k} where the index i is the column of the region, index j is the row of the image region, and index k is the frame of the image region. In the table of FIG. 11, the value of X_{i,j} is 1 if I_{i,j,k} is different from I_{i,j,k-1}. The value of X_{i,j} is 0 if I_{i,j,k} is the same as FIG. 11 thus illustrates the locations of the changed image regions between and I_{i,j,k} and I_{i,j,k-1}. Image I_{i,j,k-1} is the image currently present on the display, and image is the image to be written next.

FIG. 12 is a table of row direction counts based on the table of FIG. 11. The entries C_{i,j} for the table of FIG. 12 may be generated as follows:

C_{1,j}=X_{1,j}

for i≠1, C_{i,j}=0 if X_{i,j}=0, C_{i,j}=X_{i-1,j}+X_{i,j} if X_{i,j}=1

This will produce a count along the row of a number of adjacent display regions that are different between frame k−1 and frame k. This table can then be searched for all rows that include an entry that is larger than a threshold n. For example, if the threshold n is set to 5, this search will find that rows 3 and 4 of image regions include a value C_{i,j} that is equal to or greater than 5. In this implementation, rows 3 and 4 can be written with new data, and the other rows may be skipped. It may be noted here that rows 2 and 5 also include 5 or more changed image regions. For rows 2 and 5 however, the changed regions are distributed such that no 5 changed regions are adjacent. Therefore, these rows can be skipped without significant impact on the visual appearance of the display, therefore increasing the frame rate at a low cost in visual appearance. In some implementations, the tables of FIGS. 11 and 12 can be generated in their entireties prior to writing frame k. After the tables are generated, the rows of image regions that should be written for frame k can be determined. In other implementations, the entries of the tables of FIGS. 11 and 12 can be generated line by line for each line jas frame k is written to the display.

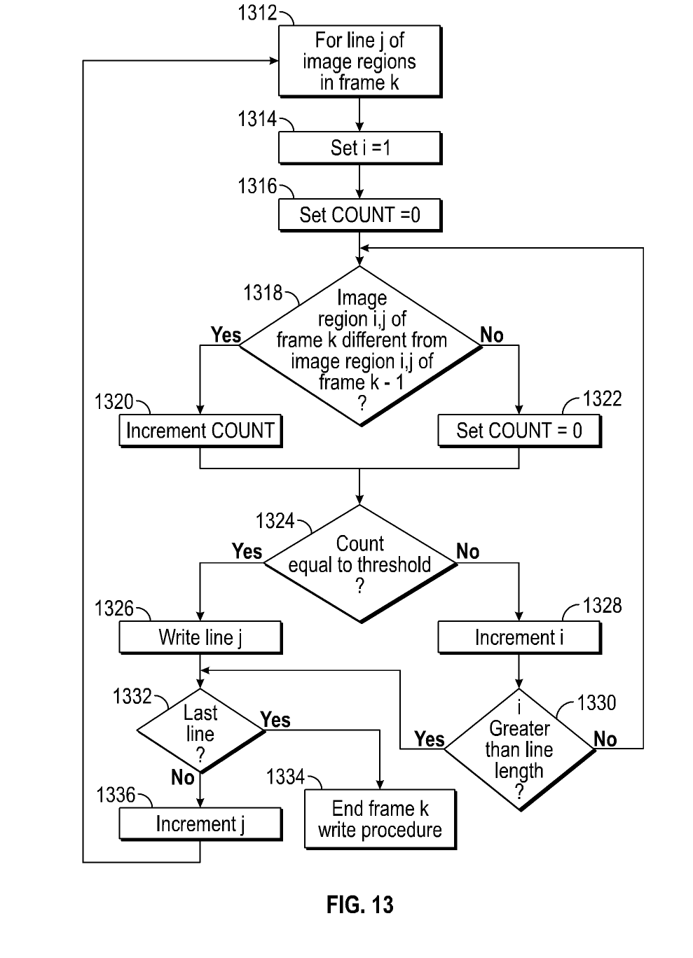

In some implementations, processing speed can be increased by stopping the computation of the table entries of FIG. 12 once a value of n (e.g. 5) has been reached. This is illustrated in FIG. 13, where FIG. 13 is a flowchart of a method of writing display data. The method of FIG. 13 begins at block 1312 where line j is analyzed for whether it should be written to the display or not. Typically, the method will begin with j=1 to analyze the first line. At block 1314, the column index i is set to 1. At block 1316, a parameter COUNT is set to 0. At decision block 1318, it is determined whether image region i,j from frame k being written is the same as or different from image region i,j of currently displayed frame k−1. If different, the value of COUNT is incremented at block 1320. If the image regions are the same, COUNT is set to 0 at block 1322. At decision block 1324, COUNT is compared to a threshold (denoted n herein). If COUNT has reached a threshold n, line j of new frame k is written to the display at block 1326. This may be advantageous for processing speed because it may not be necessary to process the entire line j before determining that it contains an adjacent series of changed image regions meeting the threshold n. If COUNT has not reached the threshold, the index i is incremented at block 1328, moving the procedure down to the next image region along line j. Moving further down this branch, at decision block 1330, it is determined whether the incremented value of i exceeds the line length. If it does not, the method returns to decision block 1328, where a comparison of image regions is again performed for the next value of i along the line of image regions. If the incremented value of i does exceed the line length, this means that the entire line j has been processed without the value of COUNT ever reaching the threshold. In this case, the process moves to decision block 1332 without performing a write procedure for line j at block 1326.

After either line j is written at block 1326, or processing of line j is complete without COUNT ever reaching the threshold, decision block 1332 determines whether the current value of j corresponds to the last line of image regions of frame k. If yes, the write procedure for frame k is complete, as denoted in block 1334. If not, the index j is incremented at block 1336, and the process loops back to block 1312 to repeat the process for the incremented value of line index j. Using the table of FIG. 11 as an example of changed image regions between frame k and k−1, and using n=5 as in the above example, rows 3 and 4 will pass through block 1326 and be written, which is the same result as computing the table of FIG. 12 described above.

The process illustrated in FIG. 13 is conveniently implemented in a programmable microprocessor or microcontroller. As an alternative, the decision to write or not write a given line j of image regions based on adjacent changed image regions can be performed nearly instantly using some discrete circuit hardware.

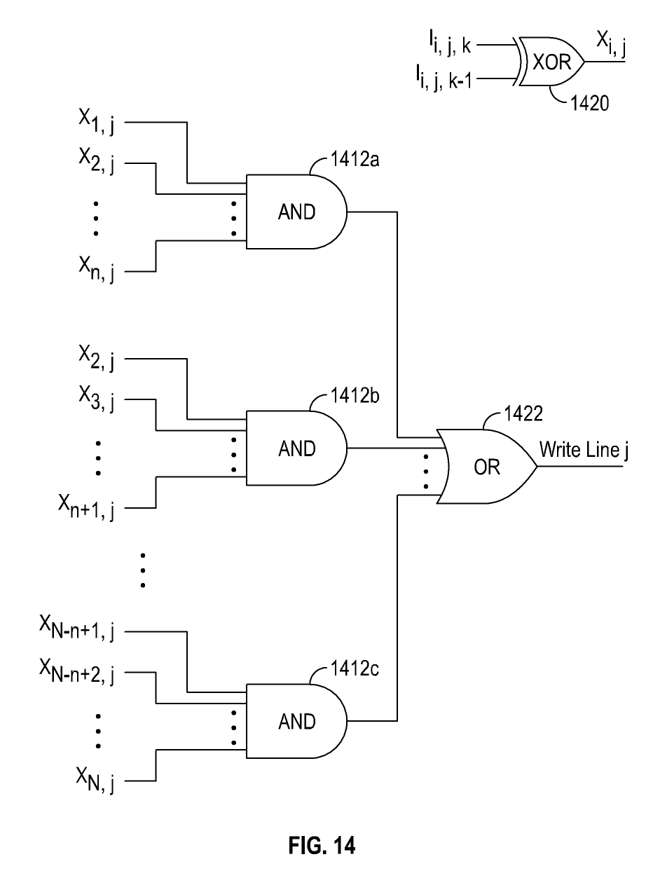

FIG. 14 is a circuit that may be used to detect a number of adjacent changed display regions. The circuit includes a series of multiple input AND gates, three of which are shown, denoted 1412a, 1412b, and 1412c. The inputs to each AND gates are a different continuous series of n X_{i,j} values produced by comparing image region I_{i,j,k} and I_{i,j,k-1} as described above. This process is represented in FIG. 14 by the XOR gate 1420 which produces an output of 1 for X_{i,j} if image region I_{i,j,k} is different than image region I_{i,j,k-1}, and which produces an output of 0 for X_{i,j} if image region I_{i,j,k} is the same as image region I_{i,j,k-1}. If the image regions are larger than a single display element, multiple XOR gates or a more complex algorithm may be employed to produce the X_{i,j} values. Along line j, each one of the possible adjacent sets of n X_{i,j} values is input to a different AND gate. In some implementations, n can be the threshold of adjacent changed display regions equal to or above which line j will be written. The output of each AND gate will be 1 if all of the n X_{i,j} inputs are 1, which will occur if all of the n adjacent image regions are different. If there are N image regions along line j, N−n+1 AND gates may be used to test each possible sequence of n adjacent image regions along line j.

The outputs of the AND gates are coupled as inputs to an OR gate 1422. The OR gate output will be a 1 if any of the AND gate outputs are 1, and will be 0 if all of the AND gate outputs are 0. An OR gate output of 1 thus indicates that somewhere along line j there is an adjacent series of n different image regions. When the OR gate output is 1 for a given line j, the system response may be to write line j with the new frame k data. Returning to the example set of X_{i,j} values in the table of FIG. 11 and a value of n of 5, the output of OR gate 1422 will be 1 for lines 3 and 4, and 0 for all other lines, producing the same decision result as was obtained with the method of FIG. 13, or by populating and searching the Table of FIG. 12 as described above.

The procedures described above are directed to finding adjacent series of image regions that are different along a line of image regions that extend along one dimension of the display. As described above, these lines of image regions may correspond to one or more common lines of the display array. It is also possible to find two-dimensional blocks of adjacent changed display regions. Such two dimensional blocks may also be visually perceptible, sometimes even more so than a one dimensional series of adjacent changed display regions.

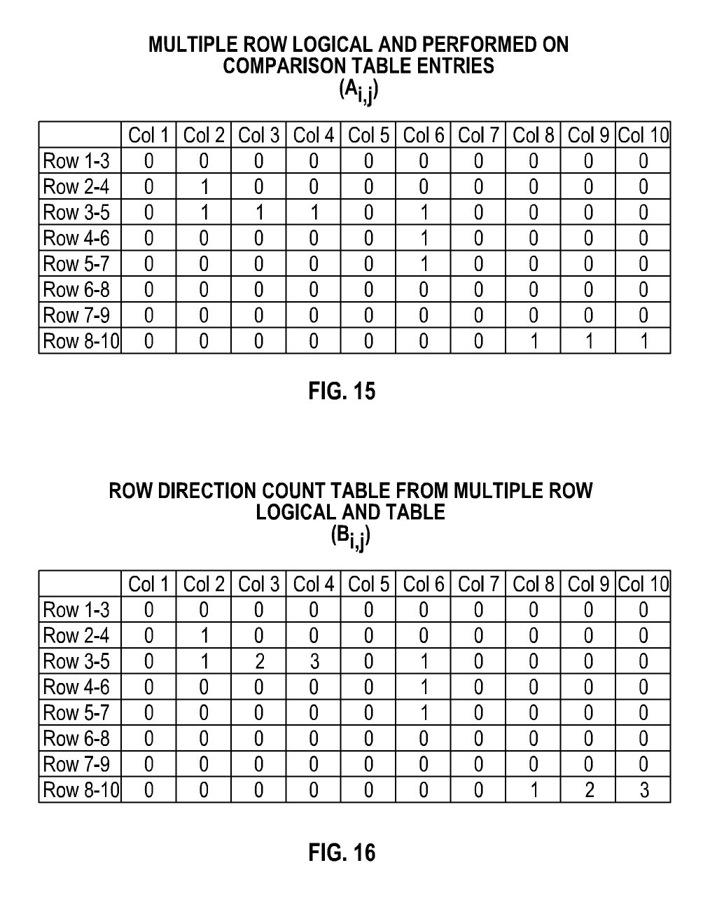

To illustrate such a block finding process, FIG. 15 is a table containing multiple row logical AND operations performed on the data in the table of FIG. 11. Given an image region comparison table of X_{i,j} values, the entries of the Table of FIG. 15 may be determined as:

A_{i,j}=1 if X_{i,j} AND X_{i,j+1} AND X_{i,j+2}=1; A_{i,j}=0 otherwise

Each row of the table of FIG. 15 corresponds to a set of rows of image regions, and the entries of the Table of FIG. 15 will be 1 if there is an adjacent series of n changed image regions in the column direction (rather than the row direction as in the implementations above), where in this example n=3.

To detect two dimensional blocks of adjacent changed image regions, a count table similar to that described above with reference to FIG. 12 can be constructed, but using as input the entries of Table 15. Thus, FIG. 16 is a table of row direction counts based on the table of FIG. 15.

B_{1,j}=A_{1,j}

for i≠1, B_{i,j}=0 if A_{i,j}=0, B_{i,j}=A_{i-1,j}+A_{i,j} if A_{i,j}=1

This will produce a count along the row of a number column aligned sets of adjacent display regions that are different between frame k−1 and frame k. This table can then be searched for all rows that include an entry that is larger than a threshold. If this threshold is set to n=3, the same as used to produce the input data A_{i,j}, a value of 3 or more in a row of the table of FIG. 16 indicates the presence of an 3×3 block of adjacent changed display regions. When a value of B_{i,j} is found in the table of FIG. 16 that is equal to or greater than n, then the rows of image regions of the display that correspond to the row j of the table of FIG. 16 where this value is found may be written to the display.

In the example image region change table of FIG. 11, there are two 3×3 blocks of adjacent changed display regions, one vertically spanning rows 3, 4, and 5, and one vertically spanning rows 8, 9, and 10. The example table entries of FIG. 16 show a value of 3 in the row corresponding to image region rows 3-5 and image region rows 8-10. In response, the system may write rows 3, 4, 5, 8, 9, and 10 of image regions with new image data from frame k, and skip rows 1, 2, 6, and 7.

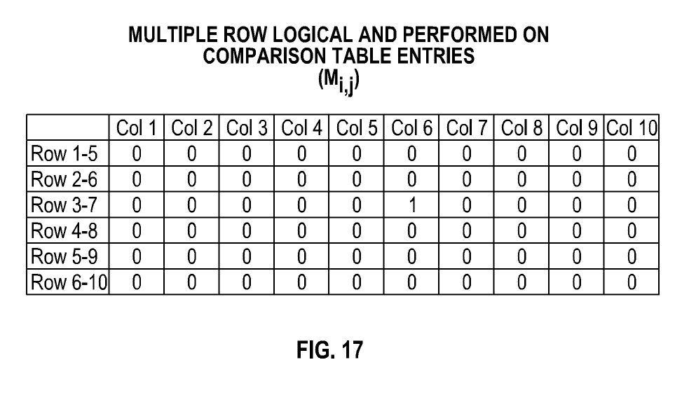

The above implementations show finding row direction adjacent series of changed display data and two dimensional blocks of adjacent changed display data. Another set of adjacent changed image regions that may be useful to detect is vertical or column oriented series of changed image regions. This is illustrated in FIG. 17, which is another table containing multiple row logical AND operations performed on the data in the table of FIG. 11. This table is constructed similarly to the table of FIG. 15, but larger row groupings corresponding to a threshold n of 5 are used. The entries of the table of FIG. 17 may be computed as follows:

M_{i,j}=1 if X_{i,j} AND X_{i,j+}1 AND X_{i,j+2} AND X_{i,j+3} AND X_{i,j+4}=1;

M_{i,j}=0 otherwise

The table entries of FIG. 17 may then be searched for any entry of 1. An entry of 1 in a row j of the table of FIG. 17 indicates that the rows of image regions corresponding to row j of the table are part of a continuous column oriented line of changed image regions. As seen in the example image region comparison table of FIG. 11, a vertical series of 5 adjacent changed display regions spans rows 3 through 7 in column 6. Thus, when computed as above, and as shown in the example of FIG. 17, a 1 appears at the M_{i,j} position corresponding to rows 3 through 7 in column 6. In response to finding this value of 1 in this position, the system may select lines 3 through 7 for writing new data from frame k to the display.

The above described detection of a number of adjacent changed image display regions can be used to determine which common lines of a display to write in a variety of manners. In one implementation, only row direction adjacencies are considered, and all common lines associated with a line j of image regions are written if the line j of image regions contains a series of adjacent changed image display regions of some threshold number or more. This may be performed with the procedure of FIG. 13 or the circuit of FIG. 14 for example. In the example set of image region changes present in the table of FIG. 11, if a threshold of 5 is set for row adjacent changed image regions, this will result in writing rows of image regions 3 and 4 and skipping the rest.

In other implementations, both row and column direction adjacencies may be considered, where all common lines associated with either row direction or column direction sets of adjacent display regions of some threshold or more are written. The threshold length of adjacent changed display regions may be the same for both row and column adjacencies or different. In the above table of FIG. 11 example, if the threshold n were set to 5 for both row direction and column direction adjacencies, rows 3 through 7 of image regions would be written and the rest would be skipped. In this case, rows 3 and 4 would satisfy both criteria, and rows 5 through 7 would be written because they are part of a column oriented set of adjacencies meeting the threshold. In some implementations, row oriented adjacencies, column oriented adjacencies, and two dimensional block type adjacencies (potentially having a different length threshold) could be found, and all common lines associated with any suOh adjacent set of display regions could be written. If this were applied to the image changes of FIG. 11, and if the threshold for linear adjacent change were 5 and the threshold for two dimensional blocks of adjacent change were 3, the system would write rows of image regions 3 through 10, skipping only rows 1 and 2. These techniques will typically result in skipping some common lines and improving frame rate, although the amount of frame rate improvement will vary depending on the nature of the changes between each image.

If a constant frame rate is desired, a set number of common lines will be written and a set number skipped for each frame. When this is the case, the above described detection of adjacent changed display regions can be used to rank common lines in an order of visual importance for writing new data. For example, common lines associated with two dimensional blocks of adjacent changed image regions could be ranked highest, followed by row oriented linear sets of adjacent changed image regions, followed by column oriented linear sets of adjacent changed image regions. In this way, the common lines that are skipped will be the lines that have the lowest visual impact on the new image being written.

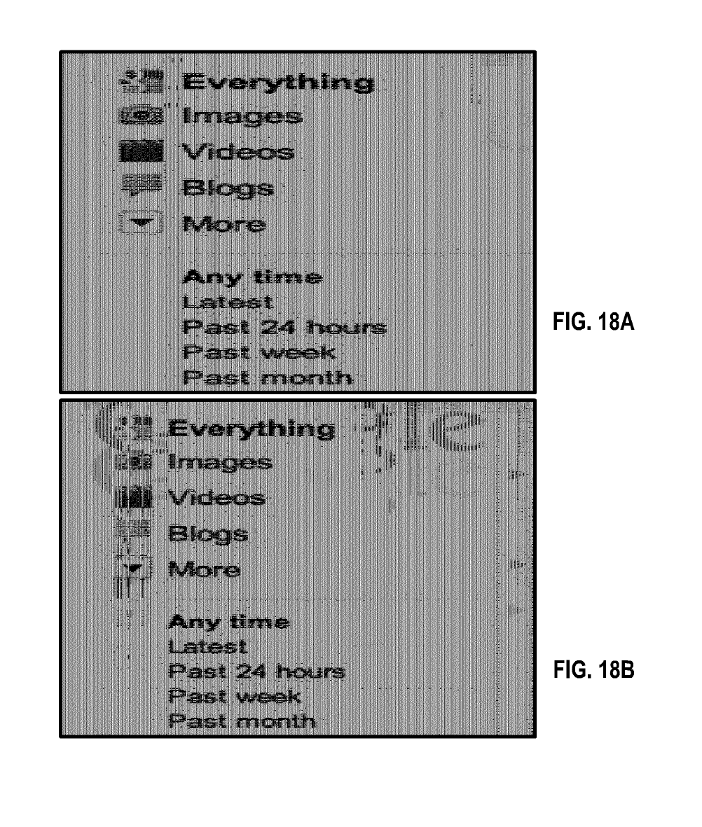

FIGS. 18A and 18B show examples of a display appearance during a scroll operation using a simple count of changed image regions along a line and a detection of clustered changes of image regions along a line. The base framerate of the device (if every line is written for each frame) in these examples is 30 Hz. FIGS. 18A and 18B show an example of images found if frame-rate is increased to 50 Hz, where FIG. 18B shows the simple count method, and 18A shows the cluster detection method (with the cluster threshold of adjacent regions set to 10). That means that on average for the sequence of images, only 60% of the lines are written per frame. Note that this number is based on frame content, so it is possible that for a particular frame all lines were written and for another frame only 10% of the lines were written.

FIG. 18B shows very noticeable artifacts during the scroll that show up as streaks when the video sequence is viewed. FIG. 18A shows the corresponding frame processed with cluster detection along lines of pixels to get the same frame rate. FIG. 18A shows fewer artifacts.

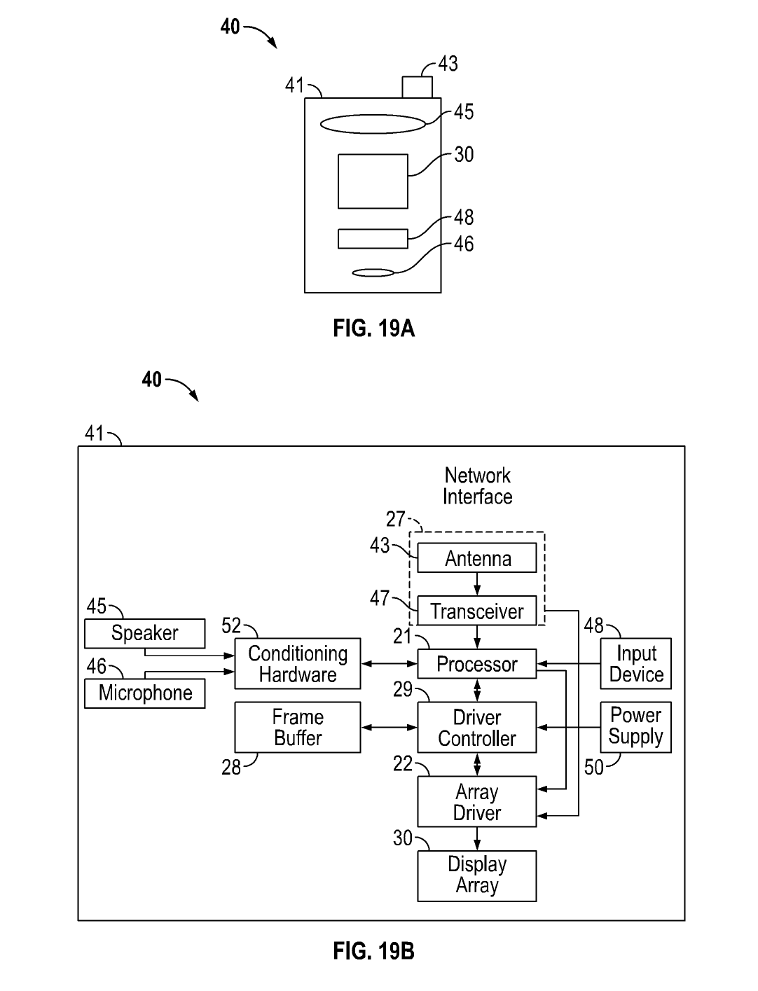

FIGS. 19A and 19B show examples of system block diagrams illustrating a display device 40 that includes a plurality of interferometric modulators. The display device 40 can be, for example, a cellular or mobile telephone. However, the same components of the display device 40 or slight variations thereof are also illustrative of various types of display devices such as televisions, e-readers and portable media players.

The display device 40 includes a housing 41, a display 30, an antenna 43, a speaker 45, an input device 48, and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber, and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an interferometric modulator display, as described herein.

The components of the display device 40 are schematically illustrated in FIG. 19B. The display device 40 includes a housing 41 and can include additional components at least partially enclosed therein. For example, the display device 40 includes a network interface 27 that includes an antenna 43 which is coupled to a transceiver 47. The transceiver 47 is connected to a processor 21, which is connected to conditioning hardware 52. The conditioning hardware 52 may be configured to condition a signal (e.g., filter a signal). The conditioning hardware 52 is connected to a speaker 45 and a microphone 46. The processor 21 is also connected to an input device 48 and a driver controller 29. The driver controller 29 is coupled to a frame buffer 28, and to an array driver 22, which in turn is coupled to a display array 30. A power supply 50 can provide power to all components as required by the particular display device 40 design. Circuitry in the processor 21 and/or the driver controller 29 can contain or perform some or all the elements of the circuits and methods described above. These may be implemented in software code executed by the processor, performed by discrete circuits, or a combination of these.

The network interface 27 includes the antenna 43 and the transceiver 47 so that the display device 40 can communicate with one or more devices over a network. The network interface 27 also may have some processing capabilities to relieve, e.g., data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g or n. In some other implementations, the antenna 43 transmits and receives RF signals according to the BLUETOOTH standard. In the case of a cellular telephone, the antenna 43 is designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G or 4G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that is readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation, and gray-scale level.

The processor 21 can include a microcontroller, CPU, or logic unit to control operation of the display device 40. The processor 21 may implement in whole or in part software instructions for performing the method of FIG. 13 for example. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. The driver controller 29 may contain the circuitry of FIG. 14 for controlling the writing of specific lines of the display. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of pixels.

In some implementations, the driver controller 29, the array driver 22, and the display array 30 are appropriate for any of the types of displays described herein. For example, the driver controller 29 can be a conventional display controller or a bi-stable display controller (e.g., an IMOD controller). Additionally, the array driver 22 can be a conventional driver or a bi-stable display driver (e.g., an IMOD display driver). Moreover, the display array 30 can be a conventional display array or a bi-stable display array (e.g., a display including an array of IMODs). In some implementations, the driver controller 29 can be integrated with the array driver 22. Such an implementation is common in highly integrated systems such as cellular phones, watches and other small-area displays.

In some implementations, the input device 48 can be configured to allow, e.g., a user to control the operation of the display device 40. The input device 48 can include a keypad, such as a QWERTY keyboard or a telephone keypad, a button, a switch, a rocker, a touch-sensitive screen, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices as are well known in the art. For example, the power supply 50 can be a rechargeable battery, such as a nickel-cadmium battery or a lithium-ion battery. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The steps of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. The word “exemplary” is used exclusively herein to mean “serving as an example, instance, or illustration.” Any implementation described herein as “exemplary” is not necessarily to be construed as preferred or advantageous over other implementations. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of the IMOD as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A method of writing image data to a display comprising:
determining that a number of adjacent display regions have changed between a portion of a previously written frame of display data and a corresponding portion of a current frame of data to be written; and
writing display data of the current frame to the changed adjacent display regions.

2. The method of claim 1, comprising:
writing display data to the changed adjacent display regions when the number is equal to or exceeds a threshold, and
retaining original display data on the changed adjacent display regions when the number is less than a threshold.

3. The method of claim 1, wherein the changed adjacent display regions are adjacent along a one dimensional line of display data.

4. The method of claim 1, comprising:
generating an ordered series of values, the ordered series corresponding to an ordered series of display regions along a line of display regions, wherein each value of the series takes a first value when the state of the corresponding display region of a second frame is different from the corresponding display region of a first frame, and wherein each value of the series takes a second value when the state of the corresponding display region of a second frame is the same as the corresponding display region of a first frame; and
generating a count of a number of adjacent first values in the ordered series of values.

5. The method of claim 1, wherein each display region is an individual display element.

6. The method of claim 1, wherein each display region is an individual image pixel.

7. The method of claim 1, wherein each display region is a group of image pixels.

8. The method of claim 1, wherein the changed adjacent display regions form a two dimensional cluster of display regions.

9. The method of claim 1, comprising:
writing a first frame of image data to the display;
obtaining a second frame of image data to be written to the display;
detecting portions of the second frame of image data that contain one and/or two dimensional clusters of display regions that contain different image data from corresponding portions of the first frame of image data;
writing at least some of the detected portions of the second frame of image data to the display; and
maintaining at least some other portions of the first frame of image data on the display.

10. The method of claim 1, wherein the determining includes counting a sequential series of changed display regions.

11. The method of claim 1, wherein the number is defined by a threshold programmed into a driver circuit.

12. A display device comprising:
an array of display elements defining a set of display regions;
a driver circuit configured to write display data to the array of display elements; and
a processing circuit coupled to the driver circuit configured to determine that a number of adjacent display regions have changed between a portion of a previously written frame of display data and a corresponding portion of a current frame of data to be written;
wherein the driver circuit is configured to write display data of the current frame to the changed adjacent display regions under the control of the processing circuit.

13. The display device of claim 12, wherein the processing circuit is configured to count a sequential series of adjacent changed display regions.

14. The display device of claim 12, wherein the driver circuit is programmed with a threshold that defines the number.

15. The display device of claim 12, wherein the processing circuit is configured to process image data, and further including a memory device that is configured to communicate with the processor.

16. The display device of claim 12, further comprising:
a controller configured to send at least a portion of the image data to the driver circuit.

17. The display device of claim 16, further comprising:
an image source module configured to send the image data to the processing circuit.

18. The display device of claim 17, wherein the image source module includes at least one of a receiver, transceiver, and transmitter.

19. The apparatus as recited in claim 12, further comprising:
an input device configured to receive input data and to communicate the input data to the processor.

20. A display device comprising:
means for determining that a number of adjacent display regions have changed between a portion of a previously written frame of display data and a corresponding portion of a current frame of data to be written; and
means for writing display data of the current frame to the changed adjacent display regions.

21. The display device of claim 20, wherein the means for writing display data includes a driver circuit.

22. The display device of claim 20, comprising:
means for generating an ordered series of values, the ordered series corresponding to an ordered series of display regions along a line of display regions, wherein each value of the series takes a first value when the state of the corresponding display region of a second frame is different from the corresponding display region of a first frame, and wherein each value of the series takes a second value when the state of the corresponding display region of a second frame is the same as the corresponding display region of a first frame; and
means for generating a count of a number of adjacent first values in the ordered series of values.

23. The display device of claim 20, comprising:
means for writing display data to the changed adjacent display regions when the number is equal to or exceeds a threshold, and
means for retaining original display data on the changed adjacent display regions when the number is less than a threshold.

24. A non-transient computer readable media having instructions stored thereon that cause a processing circuit in a display device to perform the steps of:
determining that a number of adjacent display regions have changed between a portion of a previously written frame of display data and a corresponding portion of a current frame of data to be written; and
writing display data of the current frame to the changed adjacent display regions.

25. The non-transient computer readable media of claim 24, wherein the method comprises the steps of:
writing display data to the changed adjacent display regions when the number is equal to or exceeds a threshold, and
retaining original display data on the changed adjacent display regions when the number is less than a threshold.

26. The non-transient computer readable media of claim 24, wherein the method comprises the steps of:
generating an ordered series of values, the ordered series corresponding to an ordered series of display regions along a line of display regions, wherein each value of the series takes a first value when the state of the corresponding display region of a second frame is different from the corresponding display region of a first frame, and wherein each value of the series takes a second value when the state of the corresponding display region of a second frame is the same as the corresponding display region of a first frame; and
generating a count of a number of adjacent first values in the ordered series of values.
